(19) United States
(12) Patent Application Publication
(10) Pub. No.: US 2020/0118084 A1
(43) Pub. Date: Apr. 16, 2020

(54) Weapons Accountability System

(71) Applicant: Sight Picture Tech Company, LLC, Lansing, MI (US)

(72) Inventor: Isaac A. Farmer, Lansing, MI (US)

(73) Assignee: Sight Picture Tech Company, LLC, Lansing, MI (US)

(21) Appl. No.: 16/597,568

(22) Filed: Oct. 9, 2019

Related U.S. Application Data
(60) Provisional application No. 62/743,843, filed on Oct. 10, 2018.

(51) Int. Cl. G06Q 10/10; G08G 5/00; G06F 3/0482; G01C 23/00; G06F 21/33; H04L 9/32; G06Q 10/06

(52) U.S. Cl. CPC G06Q 10/1095; G08G 5/0021; G06F 3/0482; G06Q 10/063116; G06F 21/335; H04L 9/32; G01C 23/005

(57) ABSTRACT

A weapons accountability system includes a processor and a memory coupled to the processor. The memory stores an available slot database including a set of available slots, a scheduled appointment database including a set of scheduled appointments, and instructions that, upon execution, cause the processor to obtain the set of available slots and the set of scheduled appointments, receive user input indicating a requested slot, and compare the requested slot to the obtained set of available slots and the obtained set of scheduled appointments. The instructions cause the processor to, in response to the requested slot interfering with the obtained set of available slots and the obtained set of scheduled appointments, generate and display an error message. The instructions cause the processor to, in response to the requested slot not interfering, store the requested slot as a new available slot of the set of available slots.

### CROSS REFERENCE

This application claims the benefit of U.S. Provisional Application 62/743,843, filed Oct. 10, 2018. The entire disclosure of the above application is incorporated herein by reference.

### FIELD

The present disclosure relates to systems and methods for monitoring database systems and more particularly to generating database entries for weapons accountability.

### BACKGROUND

This section provides background information related to the present disclosure and is not necessarily prior art.

The timeliness and efficiency of administrative military activities is of paramount importance. When, for example, a military member misses a scheduled weapons firing appointment, it may cause numerous logistic issues that adversely impact the timeliness and efficiency of administrative military activities.

### SUMMARY

A weapons accountability system includes at least one processor and a memory coupled to the at least one processor. The memory stores an available slot database including a set of available slots, a scheduled appointment database including a set of scheduled appointments, and instructions that, upon execution, cause the at least one processor to obtain the set of available slots and the set of scheduled appointments, receive user input indicating a requested slot, and compare the requested slot to the obtained set of available slots and the obtained set of scheduled appointments. The instructions cause the at least one processor to, in response to the requested slot interfering with the obtained set of available slots and the obtained set of scheduled appointments, generate and display an error message. The instructions cause the at least one processor to, in response to the requested slot not interfering with the obtained set of available slots and the obtained set of scheduled appointments, store the requested slot as a new available slot of the set of available slots.

In other features, the instructions, upon execution, cause the at least one processor to, in response to receiving an administrator selection, obtain a set of administrator credentials, compare the set of administrator credentials to present login credentials, and, in response to the present login credentials matching at least one administrator credential of the set of administrator credentials, display a next administrator user interface. In other features, the instructions, upon execution, cause the at least one processor to, in response to the present login credentials matching at least one administrator credential of the set of administrator credentials, obtain a set of Squadron numbers, request a Squadron number, receive the Squadron number, and, in response to the Squadron number matching at least one Squadron number of the set of Squadron numbers, display a flight screen.

In other features, the instructions, upon execution, cause the at least one processor to, in response to the flight screen being displayed, obtain a set of flight numbers, request a flight number, receive the flight number, and, in response to the flight number matching at least one flight number of the set of flight numbers, display a set of user-selectable links. Each link of the set of user-selectable links identifies a weapon option. In other features, the instructions, upon execution, cause the at least one processor to, in response to an administrator login, receive a first user identifier, obtain the set of available slots, display the set of available slots, receive a user selection of a selected available slot of the set of available slots, and update the selected available slot to be a scheduled appointment in the scheduled appointments database.

In other features, the instructions, upon execution, cause the at least one processor to, in response to an update to the scheduled appointments database, generate and transmit an appointment request to a first device associated with the first user identifier. In other features, the instructions, upon execution, cause the at least one processor to, in response to receiving a confirmation from the first device, add an indicator to the corresponding scheduled appointment indicating the first device confirmed the scheduled appointment.

In other features, the instructions, upon execution, cause the at least one processor to, in response to receiving a cancellation from the first device, generate and transmit an alert to an administrator indicating a cancellation of the scheduled appointment and update the scheduled appointment as a new available slot. In other features, the instructions, upon execution, cause the at least one processor to, in response to a present time being within a predetermined time of a first scheduled appointment of the set of scheduled appointments, identify a first user identifier corresponding to the first scheduled appointment and generate and transmit a reminder to a first device associated with the first user identifier.

In other features, the reminder indicates an appointment type and an appointment location. In other features, the memory stores an expiration database including a set of expiration dates corresponding to a set of certifications. Each expiration date of the set of expiration dates is associated with a particular user.

In other features, the instructions, upon execution, cause the at least one processor to, at a predetermined time interval, obtain the set of expiration dates; for each expiration date of the set of expiration dates, determine whether the corresponding expiration date is within a threshold time of a present date; and in response to determining the corresponding expiration date is within a threshold time of the present date, generate and transmit an expiration alert to an administrator. In other features, each scheduled appointment included in the set of scheduled appointments includes at least one of: (i) a date, (ii) a time, (iii) a Squadron identifier, (iv) a flight identifier, and (v) a user identifier.

A weapons accountability method includes obtaining a set of available slots and a set of scheduled appointments. An available slot database stores the set of available slots and a scheduled appointment database stores the set of scheduled appointments. The method includes receiving user input indicating a requested slot and comparing the requested slot to the obtained set of available slots and the obtained set of scheduled appointments. The method includes, in response to the requested slot interfering with the obtained set of available slots and the obtained set of scheduled appointments, generating and display an error message. The method includes, in response to the requested slot not interfering with the obtained set of available slots and the obtained set of scheduled appointments, storing the requested slot as a new available slot of the set of available slots.

In other features, the method includes, in response to receiving an administrator selection, obtaining a set of administrator credentials, comparing the set of administrator credentials to present login credentials, and, in response to the present login credentials matching at least one administrator credential of the set of administrator credentials, displaying a next administrator user interface. In other features, the method includes, in response to the present login credentials matching at least one administrator credential of the set of administrator credentials, obtaining a set of Squadron numbers, requesting a Squadron number, receiving the Squadron number, and, in response to the Squadron number matching at least one Squadron number of the set of Squadron numbers, displaying a flight screen.

In other features, the method includes, in response to the flight screen being displayed, obtaining a set of flight numbers, requesting a flight number, receiving the flight number, and, in response to the flight number matching at least one flight number of the set of flight numbers, displaying a set of user-selectable links. Each link of the set of user-selectable links identifies a weapon option. In other features, the method includes, in response to an administrator login, receiving a first user identifier, obtaining the set of available slots, displaying the set of available slots, receiving a user selection of a selected available slot of the set of available slots, and updating the selected available slot to be a scheduled appointment in the scheduled appointments database.

In other features, the method includes, in response to an update to the scheduled appointments database, generating and transmitting an appointment request to a first device associated with the first user identifier and adding an indicator to the corresponding scheduled appointment indicating the first device confirmed the scheduled appointment.

A weapons accountability system includes at least one processor and a memory coupled to the at least one processor. The memory stores an available slot database including a set of available slots, a scheduled appointment database including a set of scheduled appointments, and instructions that, upon execution, cause the at least one processor to, in response to receiving an administrator selection, obtain a set of administrator credentials and compare the set of administrator credentials to present login credentials. The instructions cause the at least one processor to, in response to the present login credentials matching at least one administrator credential of the set of administrator credentials, display a next administrator user interface, obtain the set of available slots and the set of scheduled appointments, and receive user input indicating a Squadron number, a flight number, a weapon, and a requested slot. The instructions cause the at least one processor to compare the requested slot to the obtained set of available slots and the obtained set of scheduled appointments and, in response to the requested slot interfering with the obtained set of available slots and the obtained set of scheduled appointments, generate and display an error message. The instructions cause the at least one processor to, in response to the requested slot not interfering with the obtained set of available slots and the obtained set of scheduled appointments, store the requested slot as a new available slot of the set of available slots.

Further areas of applicability of the present disclosure will become apparent from the detailed description, the claims, and the drawings. The detailed description and specific examples are intended for purposes of illustration only and are not intended to limit the scope of the disclosure.

### DRAWINGS

The drawings described herein are for illustrative purposes only of selected embodiments and not all possible implementations, and are not intended to limit the scope of the present disclosure.

FIGS. 1-2 are example illustrations of a plurality of devices that are configured to execute an application according to the present disclosure.

FIGS. 3-12 are example application states of the application according to the present disclosure.

FIG. 13 is a flowchart of an example control algorithm according to the present disclosure.

Corresponding reference numerals indicate corresponding parts throughout the several views of the drawings.

### DETAILED DESCRIPTION

Example embodiments will now be described more fully with reference to the accompanying drawings.

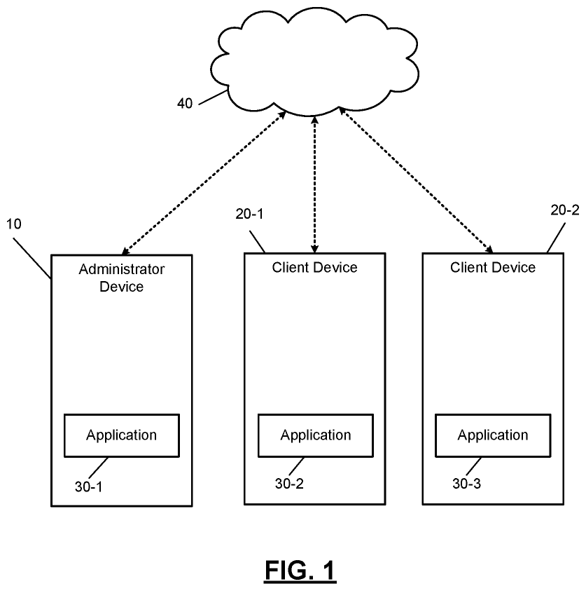

With reference to FIG. 1, administrator device 10 and client devices 20-1, 20-2 (collectively referred to as client devices 20) are shown. The administrator device 10 and the client devices 20 may be implemented by any suitable computing device, such as a mobile device, smartphone, smartwatch, desktop computer, laptop, PDA, or other similar device. Furthermore, the administrator device 10 and the client devices 20 may each include a processor that is configured to execute instructions stored in a nontransitory computer-readable medium, such as a read-only memory (ROM) and/or random-access memory (RAM).

The administrator device 10 may be associated with, for example, a military member with managerial duties (e.g., a commander), and the client devices 20 may be associated with, for example, a military member that has limited or no managerial duties (e.g., a sergeant). The administrator will also have access to reports that detail weekly to monthly analysis of pertinent information regarding appointment such as missed appointment ends, failed appointments, and attended appointments.

The administrator device 10 and the client devices 20 may each include a software application 30-1, 30-2, 30-3, respectively (collectively referred to as App 30). The App may be a software product that causes the administrator device 10 and the client devices 20 to perform a function. The functions of the App 30 may be accessed using, for example, native application editions of the software and/or web applications of the software.

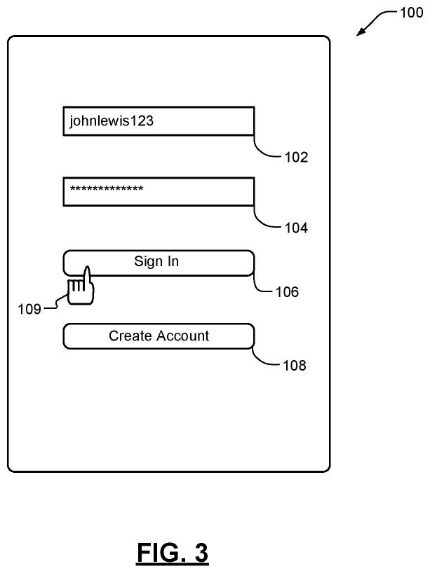

In one embodiment, the administrator device 10 and the client devices 20 are configured to, using the App 30, communicate via server 40 or a type of distributed communication system. As another example, a user of the administrator device 10 may, using the App 30, schedule and track various military activities, such as scheduling firing appointments, medical appointments, personal training tests, etc. As another example, users of the client devices 20 may, using the App 30, receive alerts corresponding to scheduled military activities. The App 30 may also be configured to store military weapons, medical, physical training, and appointment information; alert supervisors of upcoming scheduling conflicts; and inform a user of the administrator device 10 of all scheduling activities. The functions of the App 30 are described below in further detail with reference to FIGS. 3-13.

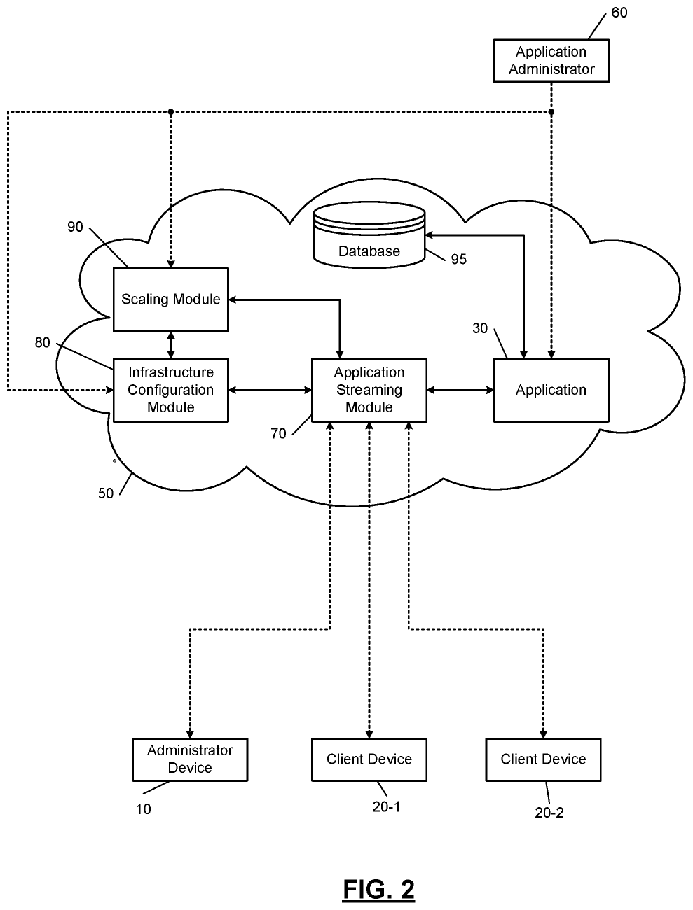

With reference to FIG. 2, the administrator device 10, the client devices 20, and a cloud computing environment 50 are shown. The cloud computing environment 50 may be a cloud service that is configured to allow a user to perform cloud computing operations. Specifically, the cloud computing environment 50 implements a plurality of virtual computers that are accessible by the administrator device 10, the client devices 20, and an application administrator 60 (e.g., an IT administrator). In one example embodiment, the application administrator 60 may deploy, using an infrastructure configuration module 80 of the cloud computing environment 50, the App 30 via an application streaming module 70. The administrator device 10 and the client devices 20 may then access the App 30 by using a web browser.

The cloud computing environment 50 may include one or more processors that are configured to execute instructions stored in a nontransitory computer-readable medium, such as a read-only memory (ROM) or a random-access memory (RAM). As an example, the cloud computing environment 50 may be implemented by Amazon Elastic Compute Cloud (EC2) provided by Amazon Web Services®. Alternatively, the cloud computing environment 50 may be implemented by the Google® Compute Engine, Microsoft® Azure, or other similar cloud computing environments.

The infrastructure configuration module 80 is configured to provide the application administrator 60 the ability to create and manage templates and any dependencies or runtime parameters associated with the templates, which configure the computing infrastructure of the cloud computing environment 50. Additionally, the infrastructure configuration module 80 may deploy and/or update a template and its associated collection of resources by using an application programming interface (API), such as JSON or YAML templates. As an example, the infrastructure configuration module 80 may be implemented by Amazon Web Services® Amazon CloudFormation.

The application streaming module 70 is configured to stream the App 30 to the administrator device 10 and the client devices 20 via an HTML5 web browser. The application streaming module 70 may stream the App 30 to the administrator device 10 and the client devices 20 regardless of an operating system type of the administrator device 10 and the client devices 20 (e.g., Microsoft Windows®, Unix®, OS X®, and Linux®). Additionally, the application streaming module 70 enables application administrators 60 to maintain a single version of the mainframe development application (i.e., the App 30) for each of the administrator device 10 and the client devices 20 and provide remote access to the App 30.

Furthermore, the application streaming module 70 provides a secure working environment, as applications and data remain on the cloud computing environment 50. In other words, the application streaming module 70 may stream encrypted pixels to the administrator device 10 and the client devices 20, and the App 30 is executed using a streaming instance dedicated to a corresponding user of the administrator device 10 and/or the client devices 20, thereby ensuring that computing resources are not shared. As an example, the application streaming module 70 may be implemented by Amazon Web Services® Amazon AppStream 2.0.

Additionally or alternatively, the cloud computing environment 50 may implement a scaling module 90 that is configured to monitor an amount of computing resources the administrator device 10 and the client devices 20 are consuming at a given time. As an example, the monitoring service may measure and provide metrics corresponding to CPU utilization, data transfer, and disk usage activity of the instances generated by the cloud computing environment 50. The monitoring service may be implemented by Amazon Web Services® CloudWatch.

Furthermore, the scaling module 90 may be configured to set alarms based on an autoscaling policy, which may be defined as an algorithm for scaling the amount of computing resources of the cloud computing environment 50 based on a number of active instances. In response to triggering an alarm, the monitoring service may send notifications and/or terminate/create instances based on the autoscaling policy.

Using the cloud computing environment 50 to develop the mainframe system 10 provides numerous benefits. As an example, using the cloud computing environment 50, the application administrator 60 is able to deploy the App 30 in a very short period of time. Furthermore, user can access the App 30 regardless of the operating system of the administrator device 10 and the client devices 20, and users can access the App 30 by using a web browser.

As another example, using the cloud computing environment 50, application administrators 60 can easily deploy application updates to the App 30 of each of the administrator device 10 and the client devices 20. Specifically, in order to update the client devices 30, the application administrator 60 may simply update the App 30 via the cloud computing environment 50. Accordingly, users of the administrator device 10 and the client devices 20 do not have to perform manual software updates to the App 30, thereby ensuring that the users are constantly able to access the latest version of the App 30 and that the users of client devices 20 are not, for example, missing firing appointments as a result of a software bug and/or error in a previous version of the App 30. In various implementations, the cloud computing environment 50 may store a database 95 accessible by the App 30. The database 95 may store known data accessed by the App 30 to display information on each user interface throughout use. For example, as will be discussed in greater detail below, the database 95 may store a set of Squadrons from which a user may select. In various implementations, the database 95 may store sets of information in order to confirm or match user text string entries.

In various implementations, the database 95 stores relevant records for all potential users, including weapons certification information. For example, each potential user requires an amount of training and an amount of certifications based on the corresponding user's status. Therefore, the database 95 stores when each user was last certified/trained on each weapon and which certifications are going to expire. A scheduler or administrator may confirm when an appointment was completed as well as add which certifications each user will need to complete. In this way, by storing expiration dates based on a most recent certification date, the system can alert users and supervisors when their certification is going to expire. For example, the system can generate and transmit an alert to an administrator indicating that a first user's particular weapon certification is going to expire. Then, the administrator can schedule the needed training for the user based on the slots made available by the scheduler.

With reference to FIGS. 3-12, example application states of the App 30 are shown. Turning to FIG. 3, an illustration of an example login App state 100 of the App 30 is shown. The App 30 may be set to the login App state 100 when a user of one of the administrator device 10 or the client devices 20 initiates the App 30. The login App state 100 may include a username input 102, a password input 104, a sign in button 106, and a create account button 108.

The login App state 100 is configured to provide the user of the App 30 with a plurality of inputs and/or user-selectable links to access the user's profile. As an example, the user may input a username associated with the user in the username input 102, and the user may then input a corresponding password associated with the user in the password input 104. Specifically, when the user selects either the username input 102 or the password input 104, the App 30 may be configured to load a keyboard on the respective administrator device 10 or client device 20. Additionally or alternatively, the App 30 may be configured to convert a voice input from the user into text in response to the user selects either the username input 102 or the password input 104. Once the user has inputted the username and password associated with the user's profile, the user may select the sign in button 106, as indicated by cartoon hand 109. If the user does not have an account, the user may select the create account button 108, which causes the App 30 to transition to an account creation state that enables the user to create an account.

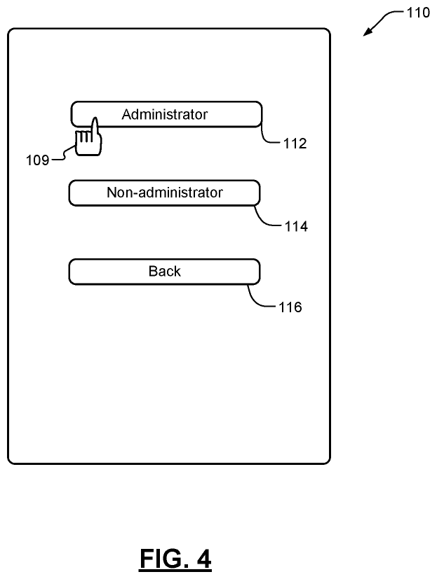

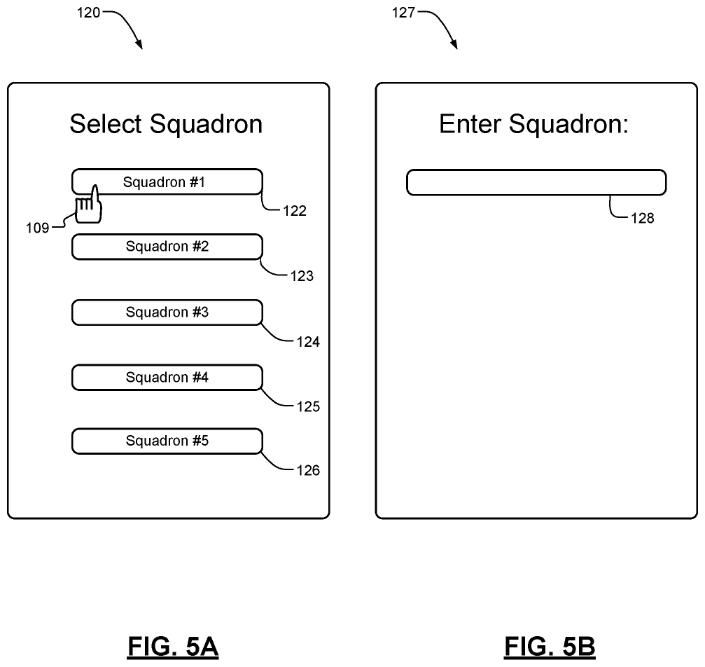

In an example embodiment, in response to selecting the sign in button 106, the App 30 transitions to a user-type app state 110 shown in FIG. 4, which enables the user to identify the type of access permissions the user desires. In response to selecting the administrator button 112, as shown by cartoon hand 109, the App 30 transitions to the administrator default app state 120, as shown in FIG. 5A. In response to selecting non-administrator button 114, the App 30 transitions to a non-administrator default app state. Button 116 enables the user to return the login app state 100. In other embodiments, the App 30 may be configured to bypass the user-type app state 110 and transition directly to one of the administrator default app state 120 or the non-administrator default app state based on information associated with the user.

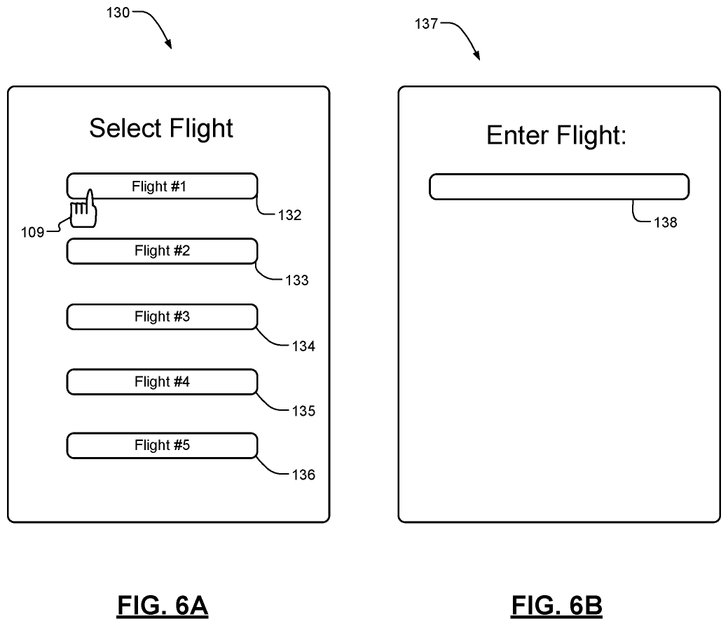

In the administrator default app state 120 shown in FIGS. 5A-5B, the user of the administrator device 10 may select one of buttons 122, 123, 124, 125, 126 that are each associated with a respective squadron. As an example, the user may select, as shown by cartoon hand 109, button 122 associated with a first squadron. In response to selecting one of the buttons 122, 123, 124, 125, 126, the App 30 is configured to transition to a flight state 130, as shown in FIG. 6A. In various implementations, the App 30 is configured to accept user input in the form of a text string instead of providing user-selectable buttons, drop down menu options, etc. For example, due to privacy concerns, the App 30 may require that all information be typed in by the user, scheduler, and/or administrator.

FIG. 5B depicts another administrator default app state 127. In the administrator default app state 127, the user of the administrator device 10 may enter the Squadron number at a text entry location 128 instead of the App 30 displaying the set of selectable Squadron numbers in FIG. 5A.

While in the flight state 130, the user of the administrator device 10 may select one of buttons 132, 133, 134, 135, 136 that are each associated with a respective flight. As an example, the user may select, as shown by cartoon hand 109, button 132 associated with a first flight. Similar to FIG. 5B, FIG. 6B depicts an alternative flight state 137 screen. The user of the administrator device 10 may enter the flight number at a text entry location 138 instead of the App 30 displaying the set of selectable flight numbers shown in in FIG. 6A. In various implementations, the App 30 is configured to receive Squadron test strings in FIG. 5B and flight text strings in FIG. 6B and then match the received text input to a set of stored existing options.

The set of stored existing options may be stored in the database mentioned previously. Therefore, once a text string entry is received, the App 30 identifies whether the text string entry matches a valid option stored in the database. If yes, the App 30 continues to the subsequent screen. Otherwise, an error is displayed. The scheduler may have permission to update the database with valid Squadrons and/or flights (or additional user data). Additionally or alternatively, the administrator may also update Squadrons and/or flights.

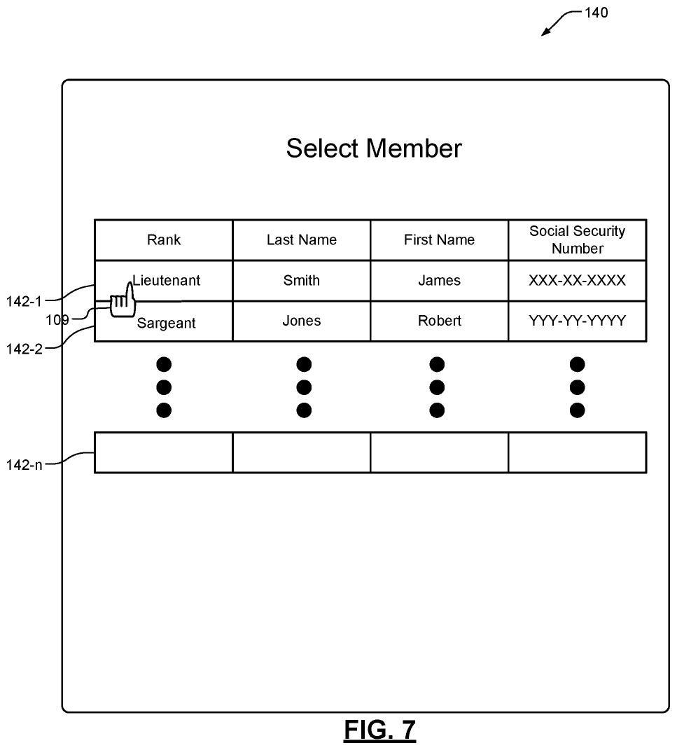

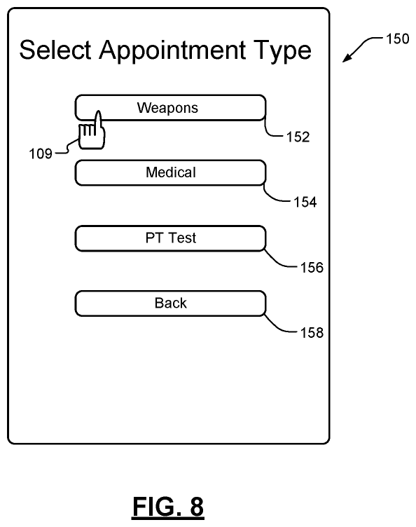

In response to selecting one of the buttons 132, 133, 134, 135, 136, the App 30 is configured to transition to a member selection state 140, as shown in FIG. 7. The member selection state 140 is configured to provide the user a plurality of entries 142-1, 142-2, . . . 142-n (collectively referred to as entries 142) for selection and subsequent scheduling of a military activity. Each of the entries 142 may include information corresponding to a rank of the military member, a first and last name of the military member, a social security number of the military member, and other identifying indicia associated with the military member. As an example, the user of the administrative device 10 may select, as shown by cartoon hand 109, a button associated with entry 142-1 (i.e., lieutenant James Smith). In response to selecting a button associated with entry 142-1, the App 30 transitions to an appointment type state 150, as shown in FIG. 8. In the appointment type state 150, the user of the administrator device 10 may select one of buttons 152, 154, 156, that are each associated with a respective military activity. As an example, the user may select, as shown by cartoon hand 109, button 152 associated with a weapons firing activity. Additionally, the user may return to the member selection state 140 by selecting button 158.

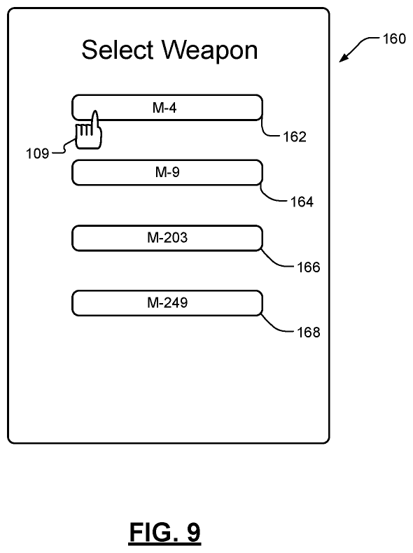

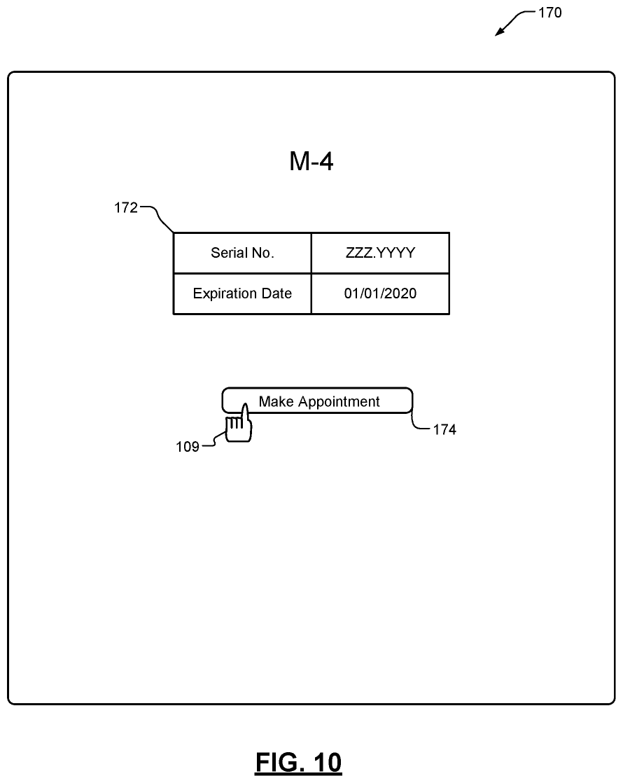

In response to selecting button 152, the App 30 may transition to a weapon selection state 160, as shown in FIG. 9. The user of the administrator device 10 may select one of buttons 162, 164, 166, 168, that are each associated with a respective weapon. As an example, the user may select, as shown by cartoon hand 109, button 162 associated with an M-4 Carbine assault rifle. In response to selecting one of the buttons 162, 164, 166, 168, the App 30 is configured to transition to a weapons state 170, as shown in FIG. 10.

In the weapons state 170 shown in FIG. 10, the App 30 may provide a table 172 that includes identifying information associated with the selected weapons, such as a serial number and an expiration date associated with the selected member's firing date approval of the respective weapon. In some embodiments, the expiration date may be represented in different colors that indicate a current proximity to the expiration date. Furthermore, the user of the administrator device 10 may make an appointment by selecting, as indicated by cartoon hand 109, button 174.

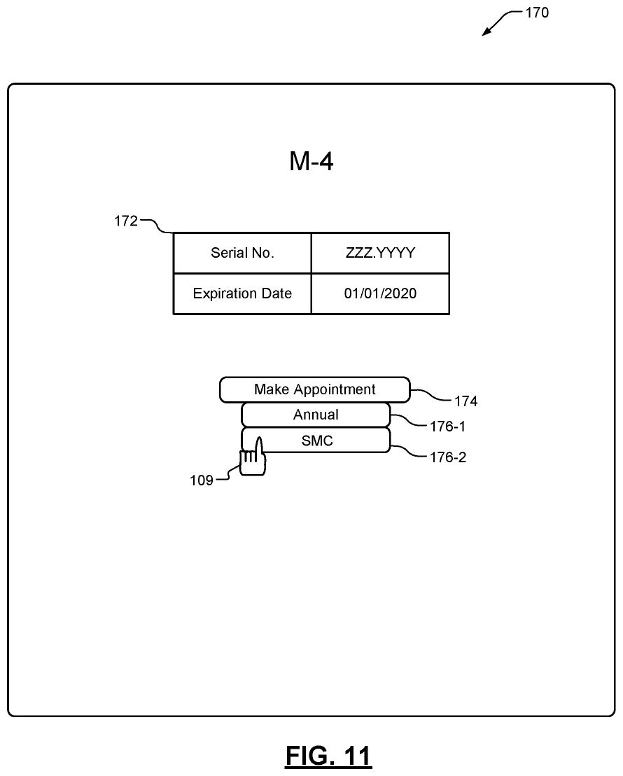

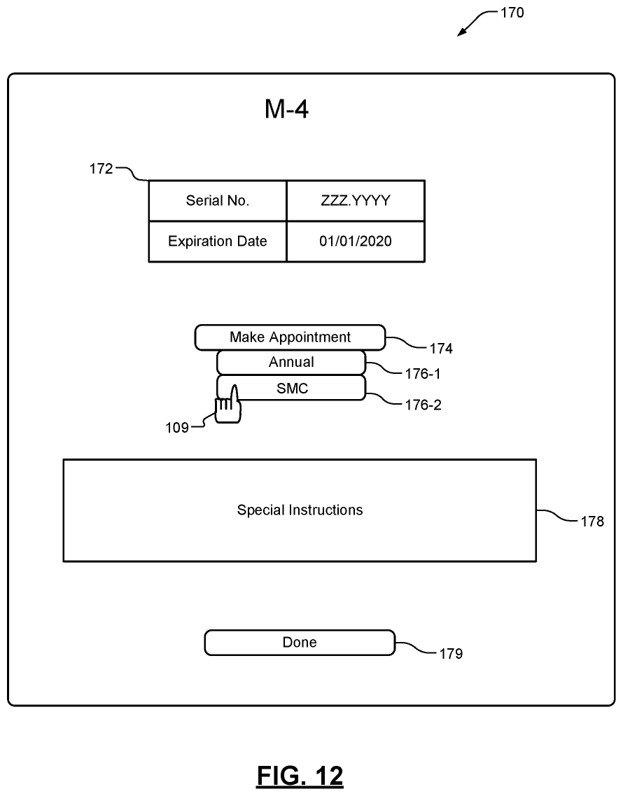

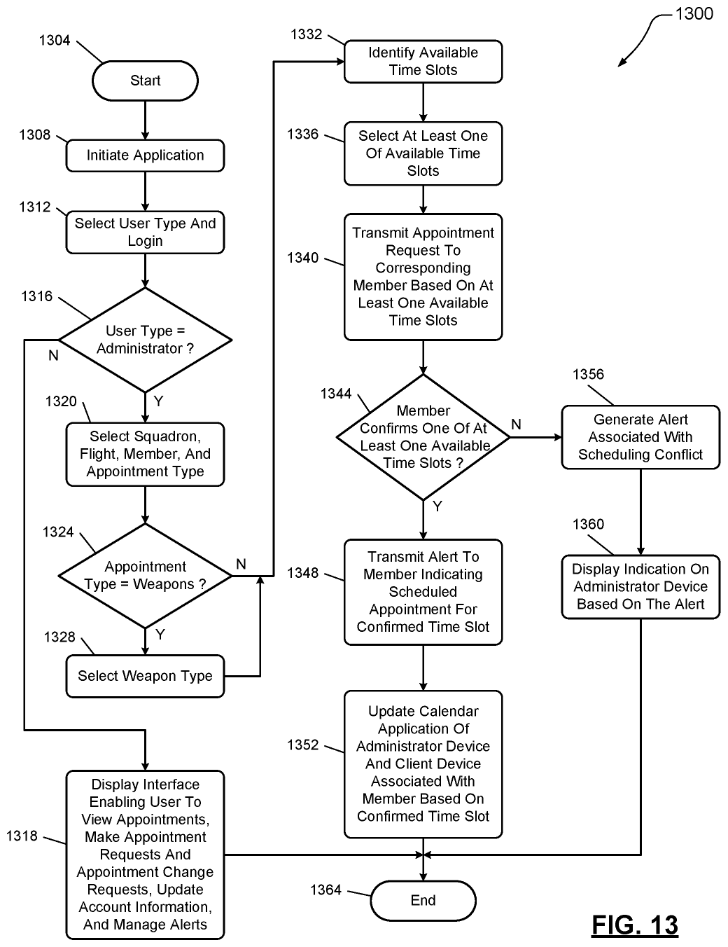

As shown in FIG. 11, selecting button 174 may cause the App 30 to display sub-buttons 176-1, 176-2 (collectively referred to as sub-buttons 176) that are associated with button 174. As an example, buttons 176-1, 176-2 may be associated with an annual appointment and a shoot-move-communicate (SMC) appointment. Alternatively, the sub-buttons 176 may be represented as options from a drop-down menu associated with button 174. In response to selecting one of the sub-buttons 176, the App 30 may provide, as shown in FIG. 12, a special instructions input 178 that enables the user to input additional textual information associated with the appointment and button 179 for confirming the appointment. In response to selecting button 179, the App 30 may transition to an appointment confirmation state, which is described below in further detail with reference to FIG. 13.

With reference to FIG. 13, a flowchart illustrating an example control algorithm 1300 is shown. The control algorithm 1300 begins at 1304 when, for example, the administrator device 10 or the client device 20 is turned on. At 1308, the control algorithm 1300 initiates, using a processor of the administrator device 10 or the client device 20, the App 30. As an example, the App 30 may be initiated by opening a local copy of the application stored in the nontransitory computer-readable medium of the administrator device 10 or the client device 20, as shown in FIG. 1. As another example, an instance of the App 30 may be executing using the cloud computing environment 50 shown in FIG. 2. At 1312, the control algorithm 1300 receives, using the App 30, information that enables the App 30 to login for a particular user and identify the type of user (i.e., administrator or non-administrator). At 1316, the control algorithm 1300 determines, using the App 30, whether the type of user is an administrator. If so, the control algorithm proceeds to 1320; otherwise, the control algorithm 1300 proceeds to 1318. At 1318, the control algorithm 1300 displays, using the App 30, an interface enabling the non-administrator user to, for example, view appointments, make appointment requests and appointment change requests, update account information, and manage alerts. The control algorithm 1300 then proceeds to 1364.

At 1320, the control algorithm 1300 receives, using the App 30, an input corresponding to the squadron, flight, a member, and an appointment type. At 1324, the control algorithm 1300 determines, using the App 30, whether the appointment type is a weapons firing appointment. If so, the control algorithm 1300 proceeds to 1328; otherwise, the control algorithm 1300 proceeds to 1332. At 1328, the control algorithm 1300 receives, using the App 30, an input corresponding to a selected weapons type (e.g., M-4 carbine assault rifle) and then proceeds to 1332.

At 1332, the control algorithm 1300 receives, using the App 30 and in response to selecting, for example, button 179 shown in FIG. 12, identifies available time slots for the weapons firing appointment. As an example, the user may manually identify available time slots. As another example, the App 30 may be configured to, using an application programming interface (API), access a calendar application of the administrator device 10 and subsequently identify available time slots.

At 1336, the control algorithm 1300 may receive, using the App 30, a selection of at least one of the available time slots. As an example, the user may manually insert the available time slots into an interface of the App 30, or the time slots may be automatically inserted into the interface of the App 30. At 1340, the control algorithm 1300 transmits an appointment request to the client device 20 of the corresponding member with information based on the at least one available time slot. At 1344, the control algorithm 1300 determines, using the App 30, whether the selected member confirms one of the at least one available time slots. If so, the control algorithm 1300 proceeds to 1348; otherwise, the control algorithm 1300 proceeds to 1356.

At 1348, the control algorithm 1300 transmits, using the App 30 an alert to the member indicating an appointment has been scheduled for the confirmed time slot. At 1352, the control algorithm 1300 updates, using the App 30 and an API, a calendar application of the administrator device 10 and the client device 20 associated with the member based on the confirmed time slot and then proceeds to 1364.

At 1356, the control algorithm 1300 generates, using the App 30, an alert associated with a scheduling conflict and then proceeds to 1360. At 1360, the control algorithm 1300 displays, using the App 30, an indication on the administrator device 10 based on the alert and then proceeds to 1364. At 1364, the control algorithm 1300 ends.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

1. A weapons accountability system, comprising:
at least one processor; and
a memory coupled to the at least one processor,
wherein the memory stores:
an available slot database including a set of available slots;
a scheduled appointment database including a set of scheduled appointments; and
instructions that, upon execution, cause the at least one processor to:
obtain the set of available slots and the set of scheduled appointments;
receive user input indicating a requested slot;
compare the requested slot to the obtained set of available slots and the obtained set of scheduled appointments;
in response to the requested slot interfering with the obtained set of available slots and the obtained set of scheduled appointments, generate and display an error message; and
in response to the requested slot not interfering with the obtained set of available slots and the obtained set of scheduled appointments, store the requested slot as a new available slot of the set of available slots.

2. The weapons accountability system of claim 1 wherein the instructions, upon execution, cause the at least one processor to, in response to receiving an administrator selection:
obtain a set of administrator credentials;
compare the set of administrator credentials to present login credentials; and
in response to the present login credentials matching at least one administrator credential of the set of administrator credentials, display a next administrator user interface.

3. The weapons accountability system of claim 2 wherein the instructions, upon execution, cause the at least one processor to, in response to the present login credentials matching at least one administrator credential of the set of administrator credentials:
obtain a set of Squadron numbers;
request a Squadron number;
receive the Squadron number; and
in response to the Squadron number matching at least one Squadron number of the set of Squadron numbers, display a flight screen.

4. The weapons accountability system of claim 3 wherein the instructions, upon execution, cause the at least one processor to, in response to the flight screen being displayed:
obtain a set of flight numbers;
request a flight number;
receive the flight number; and
in response to the flight number matching at least one flight number of the set of flight numbers, display a set of user-selectable links, wherein each link of the set of user-selectable links identifies a weapon option.

5. The weapons accountability system of claim 1 wherein the instructions, upon execution, cause the at least one processor to, in response to an administrator login:
receive a first user identifier;
obtain the set of available slots;
display the set of available slots;
receive a user selection of a selected available slot of the set of available slots; and
update the selected available slot to be a scheduled appointment in the scheduled appointments database.

6. The weapons accountability system of claim 5 wherein the instructions, upon execution, cause the at least one processor to, in response to an update to the scheduled appointments database:
generate and transmit an appointment request to a first device associated with the first user identifier.

7. The weapons accountability system of claim 6 wherein the instructions, upon execution, cause the at least one processor to, in response to receiving a confirmation from the first device:
add an indicator to the corresponding scheduled appointment indicating the first device confirmed the scheduled appointment.

8. The weapons accountability system of claim 6 wherein the instructions, upon execution, cause the at least one processor to, in response to receiving a cancellation from the first device:
generate and transmit an alert to an administrator indicating a cancellation of the scheduled appointment; and
update the scheduled appointment as a new available slot.

9. The weapons accountability system of claim 1 wherein the instructions, upon execution, cause the at least one processor to, in response to a present time being within a predetermined time of a first scheduled appointment of the set of scheduled appointments:
identify a first user identifier corresponding to the first scheduled appointment; and
generate and transmit a reminder to a first device associated with the first user identifier.

10. The weapons accountability system of claim 9 wherein the reminder indicates an appointment type and an appointment location.

11. The weapons accountability system of claim 1 wherein:
the memory stores an expiration database including a set of expiration dates corresponding to a set of certifications, wherein each expiration date of the set of expiration dates is associated with a particular user.

12. The weapons accountability system of claim 11 wherein the instructions, upon execution, cause the at least one processor to, at a predetermined time interval:
obtain the set of expiration dates;
for each expiration date of the set of expiration dates, determine whether the corresponding expiration date is within a threshold time of a present date; and
in response to determining the corresponding expiration date is within a threshold time of the present date, generate and transmit an expiration alert to an administrator.

13. The weapons accountability system of claim 1 wherein each scheduled appointment included in the set of scheduled appointments includes at least one of: (i) a date, (ii) a time, (iii) a Squadron identifier, (iv) a flight identifier, and (v) a user identifier.

14. A weapons accountability method, comprising:
obtaining a set of available slots and a set of scheduled appointments, wherein an available slot database stores the set of available slots and a scheduled appointment database stores the set of scheduled appointments;
receiving user input indicating a requested slot;
comparing the requested slot to the obtained set of available slots and the obtained set of scheduled appointments;
in response to the requested slot interfering with the obtained set of available slots and the obtained set of scheduled appointments, generating and display an error message; and
in response to the requested slot not interfering with the obtained set of available slots and the obtained set of scheduled appointments, storing the requested slot as a new available slot of the set of available slots.

15. The weapons accountability method of claim 14 further comprising, in response to receiving an administrator selection:
obtaining a set of administrator credentials;
comparing the set of administrator credentials to present login credentials; and
in response to the present login credentials matching at least one administrator credential of the set of administrator credentials, displaying a next administrator user interface.

16. The weapons accountability method of claim 15 further comprising, in response to the present login credentials matching at least one administrator credential of the set of administrator credentials:
obtaining a set of Squadron numbers;
requesting a Squadron number;
receiving the Squadron number; and
in response to the Squadron number matching at least one Squadron number of the set of Squadron numbers, displaying a flight screen.

17. The weapons accountability method of claim 16 further comprising, in response to the flight screen being displayed:
obtaining a set of flight numbers;
requesting a flight number;
receiving the flight number; and
in response to the flight number matching at least one flight number of the set of flight numbers, displaying a set of user-selectable links, wherein each link of the set of user-selectable links identifies a weapon option.

18. The weapons accountability method of claim 14 further comprising, in response to an administrator login:
receiving a first user identifier;
obtaining the set of available slots;
displaying the set of available slots;
receiving a user selection of a selected available slot of the set of available slots; and
updating the selected available slot to be a scheduled appointment in the scheduled appointments database.

19. The weapons accountability method of claim 18 further comprising, in response to an update to the scheduled appointments database:
generating and transmitting an appointment request to a first device associated with the first user identifier; and
adding an indicator to the corresponding scheduled appointment indicating the first device confirmed the scheduled appointment.

20. A weapons accountability system, comprising:
at least one processor; and
a memory coupled to the at least one processor,
wherein the memory stores:
an available slot database including a set of available slots;
a scheduled appointment database including a set of scheduled appointments; and
instructions that, upon execution, cause the at least one processor to, in response to receiving an administrator selection:
obtain a set of administrator credentials;
compare the set of administrator credentials to present login credentials;
in response to the present login credentials matching at least one administrator credential of the set of administrator credentials:
display a next administrator user interface;
obtain the set of available slots and the set of scheduled appointments;
receive user input indicating a Squadron number, a flight number, a weapon, and a requested slot;
compare the requested slot to the obtained set of available slots and the obtained set of scheduled appointments;
in response to the requested slot interfering with the obtained set of available slots and the obtained set of scheduled appointments, generate and display an error message; and
in response to the requested slot not interfering with the obtained set of available slots and the obtained set of scheduled appointments, store the requested slot as a new available slot of the set of available slots.
